(19) United States
(12) Patent Application Publication
(10) Pub. No.: US 2011/0194280 A1
(43) Pub. Date: Aug. 11, 2011

(54) LED LIGHT SOURCE FOR HAZARDOUS AREA LIGHTING

(75) Inventors: Marvin M. Ruffin, JR., Chicago, IL (US); Craig Fields, Chicago, IL (US); Mikhail Melnik, Glenview, IL (US)

(73) Assignee: EXCELITAS TECHNOLOGIES LED SOLUTIONS, INC., Wheeling, IL (US)

(21) Appl. No.: 13/025,040

(22) Filed: Feb. 10, 2011

Related U.S. Application Data
(60) Provisional application No. 61/303,006, filed on Feb. 10, 2010.

(51) Int. Cl. F21V 7/00; F21V 29/00; B23P 23/00

(52) U.S. Cl. 362/235; 362/249.02; 29/401.1

(57) ABSTRACT

An LED light source is disclosed that is configured to be retrofit to an existing lamp fixture. The existing lamp fixture is of the type including a ballast housing for providing electrical power. The retrofit assembly includes a central support connectable to the ballast housing. A circuit board is mounted to the support. The circuit board includes one or more LEDs. A dome is mounted to the support and covers the LEDs. A circumferential heat sink is mounted around the support and extends radially beyond the ballast housing to carry heat directly away from the circuit board and support.

### PRIORITY

This application claims priority to U.S. Provisional Application Ser. No. 61/303,006, filed Feb. 10, 2010, the disclosure of which is incorporated herein by reference.

### TECHNICAL FIELD

The subject invention relates to LED-based light sources for use in hazardous areas or for industrial lighting purposes.

### BACKGROUND OF THE INVENTION

“Hazardous area” lights are commonly used in locations where explosive gases or fine powders could ignite upon contact with a hot surface or electrical spark within a lamp fixture. Such hazardous area lights are also used in locations where liquids or corrosive gases could damage the lamp fixture. Such locations include, for example, oil refineries, off-shore oil platforms, chemical plants, granaries, cement plants, and food processing plants. Similarly constructed light fixtures, sometimes with less stringent sealing requirements, are also used in locations where long term exposure to moisture and dust could degrade the lamp even if no hazard exists. These locations may include large warehouse facilities (so-called “high-bay” lighting), sports stadiums, streetlights, and other outdoor facilities.

In hazardous area lighting the most common light sources today are high pressure sodium, metal halide, or mercury vapor bulbs.

These conventional bulb-based fixtures have a number of disadvantages compared to LED light sources. For example, due to the relatively large optical size of conventional bulb sources, large external optics are needed to collect and control the light. In addition, conventional bulbs typically have shorter lives and require higher operating voltages than LEDs.

There are some known LED hazardous area fixtures, such as the SafeSite LED offered by Dialight Corp. which address some of these disadvantages. However, these type of LED fixtures were designed as complete LED fixtures, and are not retrofittable or adaptable to the base housings of conventional lamp fixtures. Thus, the entire fixture must be replaced with a new LED fixture, increasing the cost of materials and labor required to change from a conventional lamp to a LED type lamp and making limited or no use of the wide array of lamp housing configurations currently available.

The design of a retrofittable LED light source presents challenges, because conventional light sources transmit the majority of their waste energy via radiation, while LEDs transmit the majority of their non-light energy via conduction. This difference in waste heat transfer creates several problems when using LEDs in fixtures designed for common light sources. For example, the housings of conventional light fixtures typically have relatively thin walls and may lack sufficient material to effectively conduct heat away from the LEDs.

In addition, the housings of conventional light fixtures typically do not have a flat and smooth surface that is suited for mounting an LED circuit board such that there will be proper heat conduction from the LEDs to the housing. Because of the high radiant energy levels from conventional bulbs, materials in close proximity to the light source typically have a high melting point. For example, materials conventionally used in the transparent enclosure (“globe”), such as glass or quartz, add size, weight and costs not needed in LED-based fixtures.

### SUMMARY OF THE INVENTION

In accordance with these and other objects, the subject invention relates to an LED-based light source that is retrofittable to existing conventional lamp fixture housings. The existing lamp fixture is of the type including a ballast housing for providing electrical power. The ballast housing typically including threads for connecting an existing, threaded dome to the ballast housing for covering the lamp.

The retrofit assembly includes a central support connectable to the ballast housing. Ideally, the support is threadably engaged with the ballast housing the existing threads on the ballast housing. A circuit board is mounted to the support. The circuit board includes one or more LEDs. A dome is sealably mounted to the support and covers the LEDs. In a preferred embodiment, a circumferential heat sink is mounted around the support and extends radially outwardly to carry heat directly away from the circuit board and support.

In the preferred embodiment, the LEDs are mounted in reflectors.

Other objects and advantages will become apparent hereinafter in view of the specification and drawings.

### BRIEF DESCRIPTION OF THE DRAWINGS

FIG. 1 is an illustration of a prior art metal-halide hazardous light fixture.

FIG. 2 is a perspective view of the support member, LED circuit board and heat sink formed in accordance with the subject invention.

FIG. 3 is an exploded perspective view of the elements of FIG. 2 and further including the dome for covering the LEDs.

FIG. 4 is an exploded perspective view similar to FIG. 3 but showing the circuit board separated from the support.

FIG. 5 is a cross-sectional view of the LED retrofit assembly mounted on a ballast housing.

FIG. 6 is a perspective view of the LED retrofit assembly mounted on a ballast housing.

FIG. 7 is a perspective view of the circuit board showing the LEDs and reflectors.

### DETAILED DESCRIPTION OF THE PREFERRED EMBODIMENT

To provide an overall understanding, certain illustrative embodiments will now be described; however, it will be understood by one of ordinary skill in the art that the systems and methods described herein can be adapted and modified to provide systems and methods for other suitable applications and that other additions and modifications can be made without departing from the scope of the systems and methods described herein.

Unless otherwise specified, the illustrated embodiments can be understood as providing exemplary features of varying detail of certain embodiments, and therefore, unless otherwise specified, features, components, modules, and/or aspects of the illustrations can be otherwise combined, separated, interchanged, and/or rearranged without departing from the disclosed systems or methods. Additionally, the shapes and sizes of components are also exemplary and unless otherwise specified, can be altered without affecting the scope of the disclosed and exemplary systems or methods of the present disclosure.

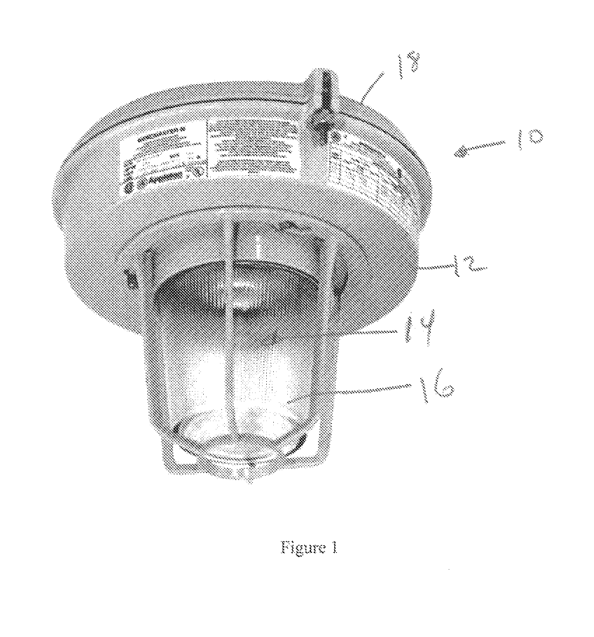

FIG. 1 is an illustration of an existing metal-halide hazardous light fixture 10. The illustrated light fixture is a MercMaster made by Appleton Electric. While a particular light fixture is shown, the subject invention is applicable to a wide range of fixtures.

Fixture 10 includes a ballast housing 12. The lamp 14 is mounted to a socket (not shown) affixed to the ballast housing. Electrical power is supplied to the lamp via the ballast housing. A transparent dome or globe 16 is threadably mounted to the ballast housing. The ballast housing is connected to a mounting base 18.

The invention of the subject invention replaces the lamp 14 with one or more LEDs. As part of this retrofit, the dome, lamp and socket are removed from the ballast housing. The elements illustrated in the remaining Figures are mounted to the ballast housing in their place.

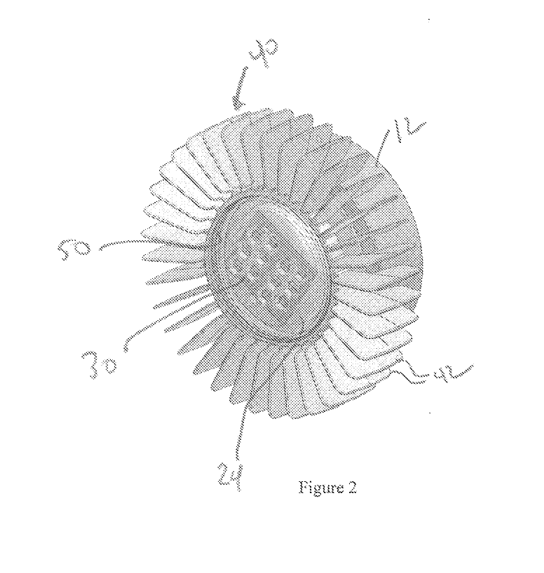

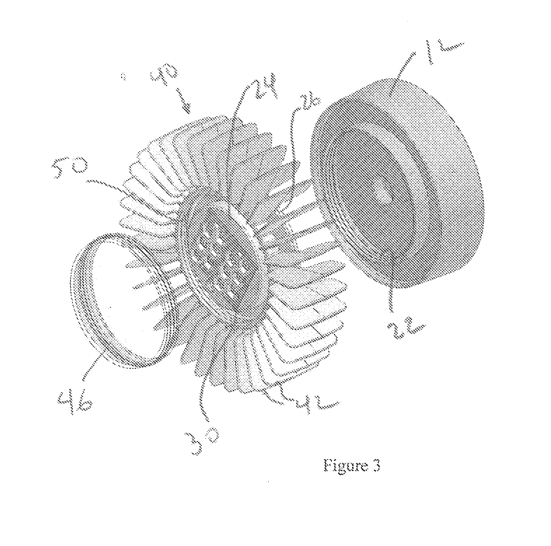

Referring now to FIGS. 2 to 7, the elements of the subject invention are illustrated. The elements can be mounted to an existing ballast housing 12. As best seen in FIG. 3, ballast housing includes a threaded portion originally designed to receive the dome 16. In a preferred embodiment, the subject invention makes use of this threaded region for mounting the elements of the subject assembly, permitting the shift to LED illumination.

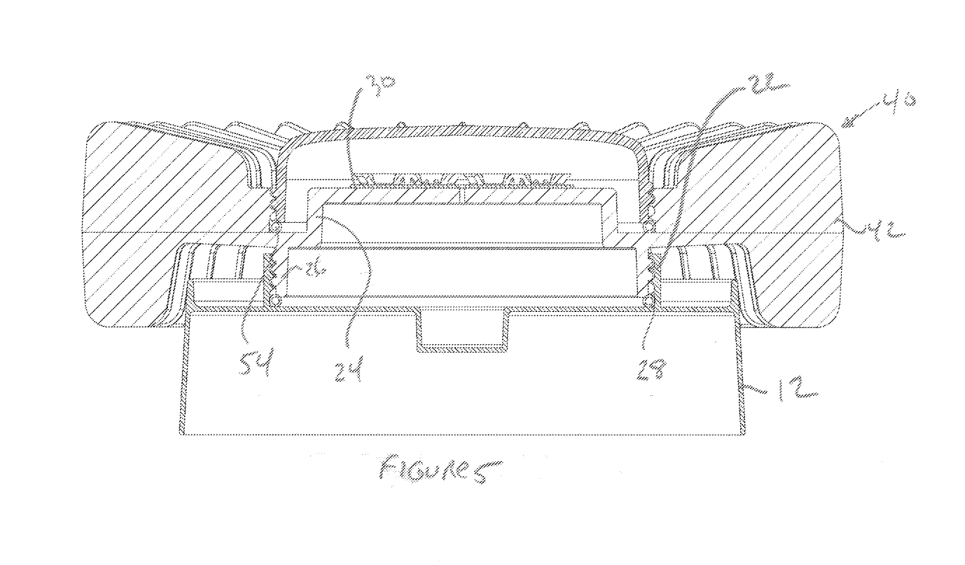

In accordance with the subject invention, the retrofit elements include a central support 24 having threads 26 which mate with threads 22 on the ballast housing. As seen in FIG. 5, preferably an O-ring gasket 28 is provided at the base of the threads to provide an environmental seal. Other attachment and sealing means may be used, depending on the design and configuration of the existing lamp fixture to which the LED light source is attached.

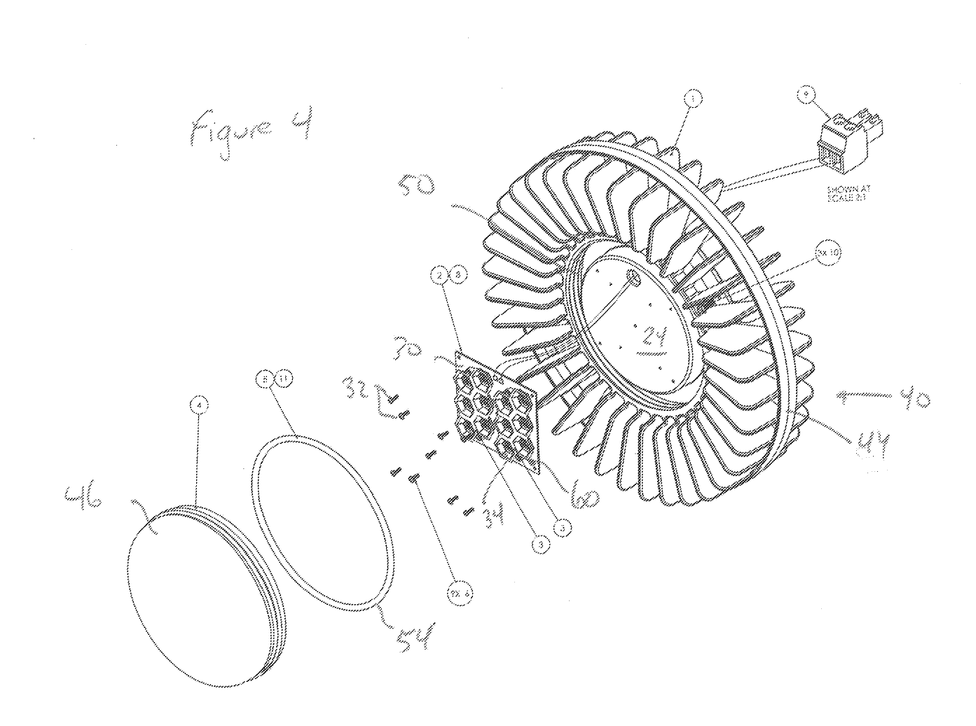

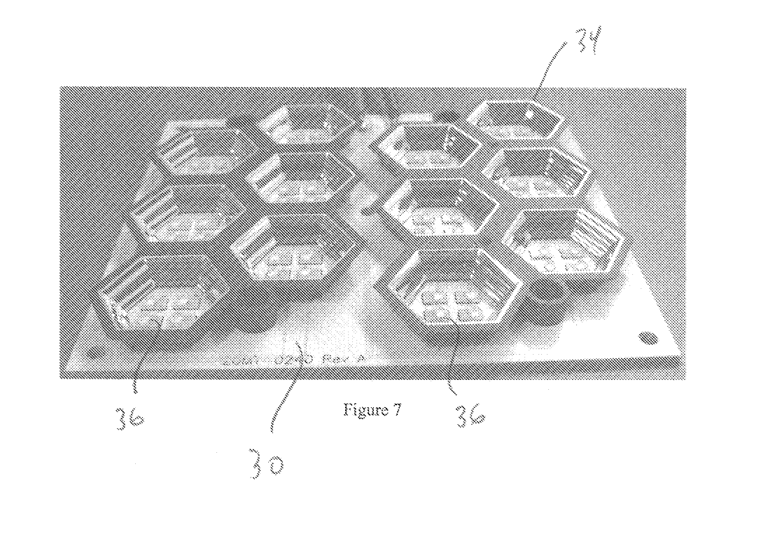

A circuit board 30 is directly mounted to the surface of support 24. The circuit board can be mounted to the support via screws 32 (FIG. 4). A more detailed view of the circuit board is illustrated in FIG. 7. In the illustrated embodiment, a set of 12 hexagonally shaped reflectors 34 are mounted on the circuit board. Each reflector surrounds a 2×2 array of LED elements 36. The sidewalls of each of the reflectors are formed from metal. While the illustrated embodiment shows a certain pattern and number of LEDs and reflectors, the subject invention is intended to cover variants, including a single, high powered LED. In a preferred embodiment, each LED is designed to produce a minimum of 100 lumens. Suitable LEDs are available from Luxeon Rebel, part number LXML-PWC-0100.

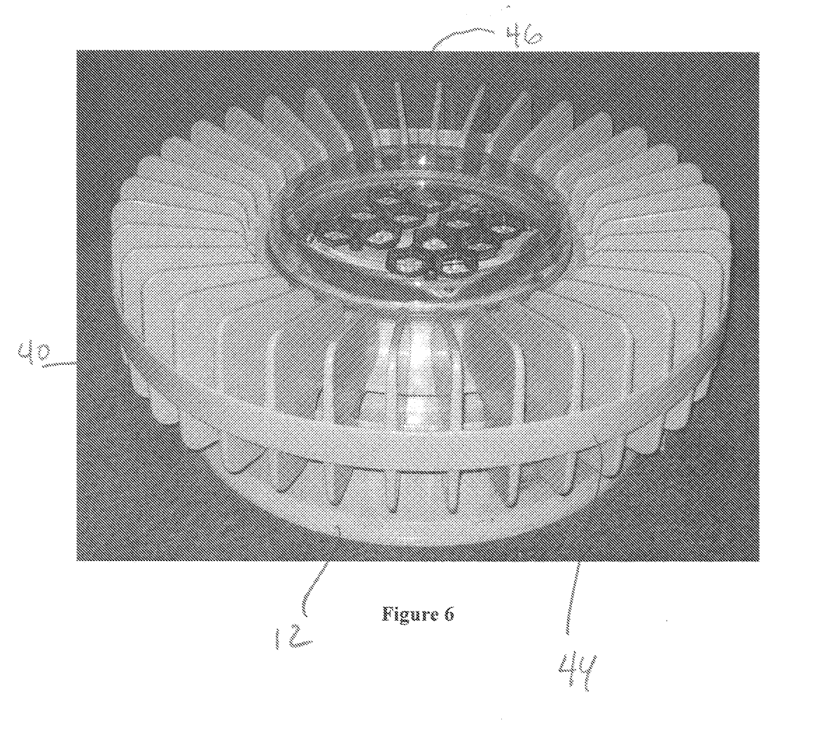

In order to provide cooling for the LEDs, a heat sink 40 is mounted circumferentially around support 24. In the illustrated embodiment, the heat sink 40 includes a plurality of fins 42 extending radially away from the support. Numerous other configurations are possible for the heat sink configuration. In the preferred embodiment, the support 24 and the heat sink are integrally formed from a single die casting. A preferred material is aluminum. As seen in FIGS. 4 and 6, the heat sink can include a band 44 which surrounds and connects the fins 42.

Preferably, the LEDs are covered by a dome 46. The dome can be threaded to mate with threads 50 in the support 24. As seen in FIG. 5, an O-ring gasket 54 is used to environmentally seal the dome to the support. FIG. 6 is a perspective view of the completed assembly.

In practice, a retrofit using this system can be fully performed in the field although it is contemplated that part of the retrofit may be performed at the manufacturer. In a field retrofit, the globe 16 would be removed and the ballast housing 12 disconnected from the mount 18. The socket would be removed and the power supply in the ballast housing would be changed to accommodate the LED's. The ballast housing would then be reconnected to the mount 18 and the support and heat sink assembly can be connected to the ballast tank.

In order to make the field replacement faster, extra, but otherwise substantially identical ballast housings could stocked. A power supply for the LEDs would be mounted in the ballast housing. The support, heat sink and dome are then connected to the ballast housing. The field engineer then brings this entire assembly to the location of the existing fixture. In the field, the old ballast housing would be disconnected from the mount 18. The retrofit assembly would then be connected to the mount. It should be noted that if separate ballast housing is used, the connection between the support and ballast housing can be more readily modified. For example, the mount could include a bolted flange.

As noted above, the LED light source of the present invention may include a heat sink to dissipate heat from the LEDs. Such a heat sink may provide adequate heat dissipation for the LEDs, irrespective of the design or mounting of the existing lamp housing to which the LED light source is attached. The heat sink may be designed such that the majority of the heat produced by the LEDs is dissipated by the heat sink to the ambient environment and is not conducted to the lighting fixture. The heat sink may be constructed of material with high thermal conductivity such as cast aluminum, and may include fins. The area under the LEDs is of sufficient thickness so that heat is conducted to the fins with little thermal resistance. The outer fins may be shaped and arranged such that natural convection dissipates heat away from the LED light source.

Multiple LEDs are mounted to a suitable substrate, which may be a printed circuit board (PCB). In a preferred embodiment, the circuit board is a metal core circuit board to improve heat transfer from the LEDs to the heat sink. The LEDs may be white high-power LEDs. Optionally, more than one LED color may be used to create a desired lighting effect. Additionally, different color LEDs may be pulsed to create a warning signal.

The reflector array is designed to collect the light emitted from each LED and the surface contours of the reflectors within the array are designed to produce a desired beam pattern. In embodiments, each reflector within the array has a similar shape and includes facets to help achieve the desired beam pattern. Reflectors may be individually mounted or may have different shapes to achieve desired beam patterns.

The dome serves the same function as the globe in a conventional lamp, which is to protect the light source from the environment and to prevent ingress of flammable gases into the electrical portions of the lamp fixture. The dome may be of plastic or glass. The dome may have facets or diffusing surfaces to achieve a desired beam pattern. As noted above, the dome may be attached to the heat sink with otherwise conventional threads and there may be a sealing gasket between the dome and the heat sink. Other commonly known attachment and sealing means may be used, such as a clamping ring or sealant adhesives.

Optionally, a proximity sensor may be added to detect a person in the locale of the lamp. When a person approaches the fixture, the lamp will turn on or increase its brightness level. When the person leaves the detection area, the fixture turns off or reduces its brightness, thus reducing the total amount of energy consumed by the fixture. A proximity sensor 60 can be mounted to the circuit board as shown in FIG. 4. As an alternative, sensor 60 could be a motion sensor.

In addition, an optional chemical vapor or smoke sensor may be added to detect high levels of chemical vapor or smoke. In this case, a second LED color may be added to the LED array. The second LED color may act as a warning light and the LEDs of the second color may be turned on once smoke or chemical vapor is detected. To further draw attention to the fixture the white and/or colored LEDs may be flashed. This combination of a sensor and a visible alarm is intended to provide a localized indication of danger.

In some embodiments, in addition to the heat sink for dissipation of the heat from the LEDs, heat may also be conducted away from the LEDs by the use of heat pipes. In some embodiments forced air convection may be included in the device to assist in heat dissipation from the heat sink. Various forms and configurations of the heat sink may be used. In addition, means other than threads may be used to attach the LED light source to the existing housing.

The LED light source of the present invention may be easily retrofitted to existing light fixtures in-situ, thus eliminating the need for the user to change lighting supports and mounting pendants. With appropriate modifications, the LED light source of the invention may be mounted to a manufacturer's wide variety of existing housings without requiring the manufacturer to create and qualify new housings. The LED light source of the invention is designed to conduct and dissipate heat from the LEDs independently of the particular design or construction of the existing lamp housing. With less radiant energy, components in close proximity to the light source can be made from material with a low melting point. For example, the dome protecting the LEDs and optics from the environment may be plastic rather than glass. Since LEDs are comparably smaller light sources and thus allow for smaller optics, the LED light source of the present invention is advantageous over existing conventional bulb-based devices. In addition, LEDs have a longer life than bulb-based light sources.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, can be made by those skilled in the art. Accordingly, it will be understood that the present disclosure is not to be limited to the embodiments disclosed herein, can include practices otherwise than specifically described, and is to be interpreted as broadly as allowed under the law.

We claim:

1. An LED retrofit kit for an existing lighting fixture having a standard bulb, said lighting fixture including a ballast housing for providing electrical power, said kit comprising:
a central support connectable to the ballast housing;
a circuit board mounted to the support, said circuit board carrying at least one LED;
a dome mounted to the support and covering the at least one LED; and
a heat sink thermally coupled to the circuit board and support.

2. A retrofit kit as recited in claim 1, where said ballast housing includes threads for connecting an existing, threaded dome, and wherein said support includes threads for connecting the support to the threads of the ballast housing.

3. A retrofit kit as recited in claim 1, wherein the heat sink is connected to the support.

4. A retrofit kit as recited in claim 3, wherein said heat sink is circumferentially disposed about said support and includes a plurality of radially extending fins.

5. A retrofit kit as recited in claim 3, wherein said support and said heat sink are integrally formed.

6. A retrofit kit as recited in claim 5, wherein said support and heat sink are die cast.

7. A retrofit kit as recited in claim 1, wherein said support includes threads for sealably mounting the dome to the support.

8. A retrofit kit as recited in claim 1, wherein a plurality of LEDs are mounted to the circuit board.

9. A retrofit kit as recited in claim 8, further including reflectors, each reflector surrounding a group of LEDs mounted on the circuit board.

10. A retrofit kit as recited in claim 1, further including a proximity sensor for detecting the presence of a person close to the fixture.

11. An LED retrofit kit for an existing lighting fixture having a standard bulb, said lighting fixture including a ballast housing for providing electrical power, said ballast housing including threads for connecting an existing, threaded dome to the ballast housing, said kit comprising:
a central support connectable to the ballast housing and including threads for mating to the threads of the ballast housing;
a circuit board mounted to the support, said circuit board carrying a plurality of LEDs;
a dome mounted to the support and covering the LEDs; and
a circumferential heat sink mounted around the support and extending radially outwardly to carry heat directly away from the circuit board and support.

12. A retrofit kit as recited in claim 11, wherein said support is mated to the ballast housing with an environmental seal.

13. A retrofit kit as recited in claim 12, wherein the seal is provided by a gasket.

14. A retrofit kit as recited in claim 11, wherein said support and said heat sink are integrally formed.

15. A retrofit kit as recited in claim 14, wherein said support and heat sink are die cast.

16. A retrofit kit as recited in claim 11, wherein said support includes threads for sealably mounting the dome to the support.

17. A retrofit kit as recited in claim 11, further including reflectors, each reflector surrounding a group of LEDs mounted on the circuit board.

18. A retrofit kit as recited in claim 11, further including a proximity sensor for detecting the presence of a person close to the fixture.

19. A method of retrofitting an existing lighting fixture having a standard bulb with one or more LEDs, said existing lighting fixture including a ballast housing for providing electrical power, said ballast housing including threads for connecting an existing, threaded dome to the ballast housing, said method comprising the steps of:
providing a central support including threads for mating to the threads of the ballast housing, said central support including a circuit board mounted thereto and carrying a plurality of LEDs, and wherein a heat sink is radially mounted around the support;
screwing the support into the ballast; and
connecting a dome to the support to cover the LEDs.
